(19) United States
(12) Patent Application Publication
(10) Pub. No.: US 2015/0082961 A1
(43) Pub. Date: Mar. 26, 2015

(54) APPARATUS FOR CUTTING OR PUNCHING A FLAT WORKPIECE

(71) Applicants: Hansjoerg Klein, Aichwald (DE); Martin Griesinger, Metzingen (DE); Mario Kneule, Frickenhausen (DE)

(72) Inventors: Hansjoerg Klein, Aichwald (DE); Martin Griesinger, Metzingen (DE); Mario Kneule, Frickenhausen (DE)

(21) Appl. No.: 14/394,087

(22) PCT Filed: Mar. 25, 2013
(86) PCT No.: PCT/EP2013/056251

§ 371 Date: Oct. 11, 2014

(30) Foreign Application Priority Data
May 2, 2012 (DE) 10 2012 207 241.1

(51) Int. Cl. B26D 7/26; B26F 1/44; B26F 1/40; B26F 1/12

(52) U.S. Cl. CPC B26D 7/2614; B26F 1/12; B26F 1/44; B26F 1/40; B26D 2007/2657
USPC 83/437.1; 83/751

(57) ABSTRACT

The invention relates to a device for machining leaf- or sheet-shaped goods, comprising a machine frame in which punching and/or cutting tools (4) are mounted, said tools carrying out a vertical stroke for cutting purposes. The machine frame consists of two parts, a lower stationary frame (1) and a cassette-type housing (2) which is movably mounted on the frame (1) in a horizontally transverse manner. The tool receiving portions (3) are mounted in the cassette-type housing in a vertically movable manner.

The invention relates to an apparatus for processing sheets having a machine frame, in which punching and/or cutting tools are mounted that perform a vertical stroke for cutting purposes.

In order to produce writing pads, notebooks or other goods that are formed from bound sheets, systems are known that comprise apparatuses having punching and/or cutting tools that perform a vertical stroke for cutting purposes. For instance, automatic manufacturing systems for spiral-bound or wire comb-bound pads comprise devices in which rows of holes for later binding are made by way of punching and at the same time partial stacks are manufactured by way of slitting by means of knives that move up and down.

In the case of a change of the tools that is necessary, for example, as a result of a format change, it is required in a complicated manner in the case of the known apparatuses to change or to adjust the tools within the stationary machine frame.

The invention is therefore based on the object of improving an apparatus of the generic type in such a way that the changeover time that is required for adjusting or changing the punching or cutting tools is shortened considerably.

According to the invention, this object is achieved by virtue of the fact that the machine frame of the apparatus consists of two pieces, a lower stationary frame and a cassette-like housing that is mounted on the frame such that it can be moved transversely in a horizontal manner, the tool holders being mounted vertically movably in the cassette-like housing.

This construction permits the housing to move transversely next to the stationary frame into a readily accessible region, in order to carry out the changeover work. Subsequently, the housing is moved back into its working position on the stationary frame again in a simple and rapid manner.

The conveying elements for the sheets, in particular the conveyor belts, on which the goods are transported in a lying manner, are preferably also mounted in the cassette-like housing.

It is advantageous if all the drives and suction assemblies are mounted in the stationary frame.

The movable housing preferably consists of two cassettes that are arranged inside one another, the outer cassette being is mounted such that it can be moved horizontally on the stationary frame and the inner cassette being mounted in the outer cassette such that it can be moved vertically, in order for it to be possible to perform the cutting stroke. The inner cassette therefore also contains the tool holders.

In order for it to be possible to move the housing with the tool holders at least into a freely accessible region, according to one embodiment of the invention rails that extend transversely with respect to the conveying section of the goods are arranged in a stationary manner next to the fixed frame so as to run horizontally. The rails are aligned with the upper edge of the stationary frame, with the result that the housing can be moved onto the rails next to the frame.

A movable carriage that can be coupled to the stationary frame makes a complete change of the housing possible. The carriage comprises rails at the level of the upper edge of the frame, onto which rails the housing can be moved for changing purposes. For instance, two or more differently equipped housings can be moved selectively into their working position. The changeover of a housing can then take place during running operation using another housing.

In its working position on the frame, the movable housing can advantageously be coupled to said frame without tools. Here, the drives also couple without tools.

In the following text, the invention will be explained in greater detail using two preferred exemplary embodiments.

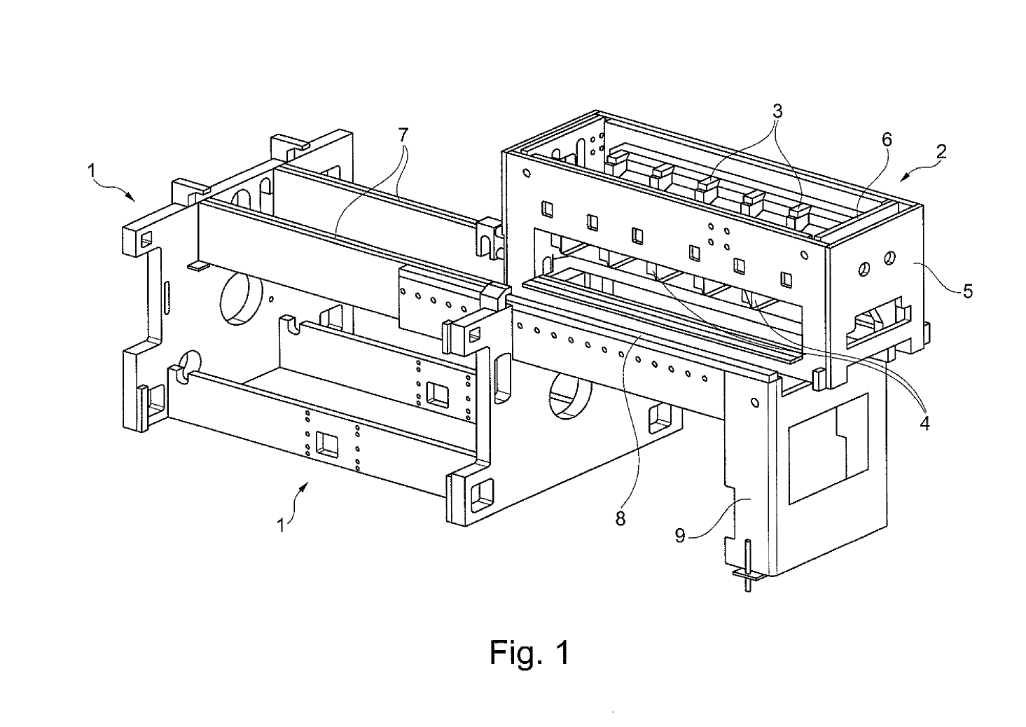

FIG. 1 shows an oblique view of the essential parts of an apparatus that makes it possible to move the housing with the tool holders next to the frame.

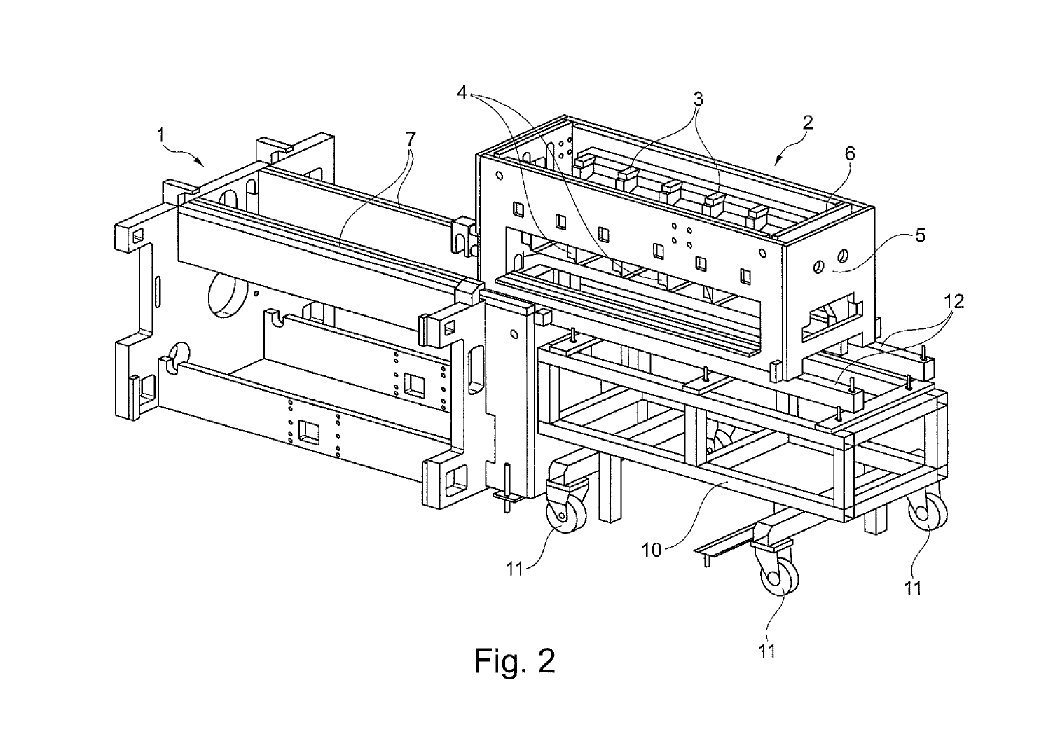

FIG. 2 shows another embodiment having a movable carriage that receives a housing for changing purposes.

The apparatus that is shown in details in the figures is part of a system, in which, starting from paper reels, books that are bound by way of wire combs or spirals are manufactured. Said apparatus serves to manufacture partial stacks that consist of individual sheets by way of slitting, which partial stacks are subsequently provided by way of punching with a row of holes, through which spirals or wire combs can be guided for binding purposes.

In both embodiments, the apparatus comprises a machine frame that consists of two pieces, a lower stationary frame 1 and a cassette-like housing 2 that is mounted on the frame 1 such that it can be moved transversely in a horizontal manner. The tool holders 3 are mounted vertically movably in the housing 2. Punching and/or cutting tools 4 that perform a vertical working stroke for cutting or punching purposes are fastened exchangeably to the holders 3. In order for it to be possible to set different leaf or sheet formats, the tool holders 3 are additionally mounted in the housing 2 such that they can be adjusted transversely. The conveying elements for the sheets are likewise mounted in the housing 2. The conveying elements are preferably conveyor belts, on which the goods are transported in a lying manner.

All the drives and suction assemblies of the apparatus are mounted in the lower stationary frame 1. Just like the conveying elements, said drives and suction assemblies are not shown in the figures.

The movably mounted housing 2 advantageously consists of two cassettes 5, 6 that are arranged inside one another, the outer cassette 5 being horizontally movable. The inner cassette 6 is mounted vertically movably in the outer cassette 5 and comprises the tool holders 3 with the tools 4 that are fastened thereto. The vertical movability of the inner cassette 6 within the outer cassette 5 makes it possible to perform the vertical working stroke that is required for cutting and punching purposes.

FIGS. 1 and 2 show different embodiments, in which the housing 2 is moved laterally next to the frame 1 for changeover purposes. During the return movement of the housing 2 into its working position on the frame 1, it is coupled to the latter without tools. Here, the drives that are mounted in the frame 1 also couple without tools to the elements to be driven, in particular the tools 4 and the conveying elements.

In the embodiment according to FIG. 1, two further rails 8 are arranged laterally next to the rails 7, by which the upper edge of the frame 1 is formed. The rails 8 run horizontally transversely with respect to the conveying section of the goods in a manner that is aligned with the rails 7 on the upper edge of the frame 1. They are fastened at one end to the frame 1 and at their other end to stands 9 that are arranged at a spacing from the frame 1. The housing 2 can thus be moved on the rails 7, 8 from its working position on the frame 1 transversely into a position next to the frame 1, in which position its inner cassette 6 with the tool receptacles 3 and tools 4 situated therein is readily accessible for changeover purposes.

FIG. 2 shows one advantageous embodiment, in which exchangeable housings 2 can be used to further shorten the changeover time. The apparatus comprises a carriage 10 with wheels 11, which carriage 10 supports two rails 12 at the level of the upper edge of the frame 1, which rails 12 can be connected in an aligned manner to the rails 7 of the frame 1. The housing 2 with the cassettes 5, 6 can thus be moved from the rails 7 onto the rails 12 of the carriage and can therefore be moved away freely from the frame 1. By way of the same or another carriage 10, a second housing 2 that has been changed over can subsequently be moved very rapidly into its working position on the frame 1. The changeover of a housing 2 is thus possible during running operation by way of another housing 2.

1. An apparatus for processing sheets and having a machine frame on which punching and/or cutting tools are mounted that perform a vertical stroke for cutting purposes, wherein the machine frame consists of two pieces, a lower stationary frame and a cassette-like housing that is mounted on the frame such that it can be moved transversely in a horizontal manner, the tool holders being mounted vertically movably in the cassette-like housing.

2. The apparatus as claimed in claim 1, further comprising:
conveyor belts for the sheets also mounted in the cassette-like housing.

3. The apparatus as claimed in claim 1, further comprising:
drives and suction assemblies mounted in the stationary frame.

4. The apparatus as claimed in claim 1, wherein the housing consists of inner and outer cassettes inside one another, the outer cassette being mounted such that it can be moved horizontally and the inner cassette being mounted in the outer cassette such that it can be moved vertically and containing the tool holders.

5. The apparatus as claimed in further comprising:
rails that extend transversely with respect to the conveying section of the goods and that are stationary next to the fixed frame so as to run horizontally, the rails being aligned with an upper edge of the frame for movement of the housing next to the frame.

6. The apparatus as claimed in claim 1, further comprising:
a movable carriage that can be coupled to the frame and that has rails at the level of an upper edge of the frame, onto which rails the housing can be moved for changing purposes.

7. The apparatus as claimed in claim 1, wherein, in its working position on the frame, the movable housing can be coupled to the frame without tools.
